(19) United States
(12) Patent Application Publication
(10) Pub. No.: US 2017/0228705 A1
(43) Pub. Date: Aug. 10, 2017

(54) SECURE ELECTRONIC STORAGE DEVICES FOR PHYSICAL DELIVERY OF DIGITAL CURRENCIES WHEN TRADING

(71) Applicant: ENVIRONMENTAL FINANCIAL PRODUCTS, LLC, Chicago, IL (US)

(72) Inventors: Richard L. SANDOR, Chicago, IL (US); Murali KANAKASABAI, Chicago, IL (US); Rafael L. MARQUES, Chicago, IL (US)

(21) Appl. No.: 15/502,075

(22) PCT Filed: Mar. 6, 2015
(86) PCT No.: PCT/US2015/019105

§ 371 Date: Feb. 6, 2017

Related U.S. Application Data
(60) Provisional application No. 62/041,623, filed on Aug. 25, 2014.
(60) Provisional application No. 62/041,619, filed on Aug. 25, 2014.

(51) Int. Cl. G06Q 20/06; H04L 29/06; G06Q 40/02; G06Q 40/04

(52) U.S. Cl. CPC G06Q 20/0658; G06Q 40/04; H04L 63/10; H04L 63/083; G06Q 40/02; G06Q 20/36

(57) ABSTRACT

The invention relates to a method to facilitate trading of digital currencies, which comprises electronically storing an amount of a digital currency on an electronic storage device or electronic registry; and physically storing the storage device or electronic registry in a secure, physical repository that is not publicly accessible with the storage device or electronic registry available for use in subsequent delivery of the digital currency.

### FIELD OF THE INVENTION

This invention relates to digital currencies. More specifically, it relates to an automated method and system for facilitating trading and taking physical delivery of digital currencies.

### BACKGROUND OF THE INVENTION

Digital currencies are created and exchanged independently of any government or bank. The currency is generated through a computer program and can be converted into cash after being deposited into virtual wallets. The classes of digital currencies at the moment include Bitcoins, Lite Coins, and Doge Coins and others are expected to be developed in the future.

Digital currencies are also called as “digital crypto-currency” as they exist as a cryptographic protocol and a virtual currency which gives consumers a way to exchange money for free or a nominal fee. “Crypto” refers to the fact that the currency is secured by cryptography, making it improbable for hackers to spend the digital currency from someone else's wallet.

No centralized regulatory authority controls digital currencies: instead, it is controlled by all digital currency users around the world. While developers improve the software, they cannot force a change in the digital currency protocol because the virtual currency can only work correctly only if and when there is a consensus among user computers.

As a digital transfer protocol, digital currency inherently operates as a money transfer medium that is sent digitally: i.e., currencies transferred from user to user without the need of a third party intermediary. It is digital, meaning it only exists in a digital format and there are no tangible properties to this currency, just like e-mails which are digital letters.

Digital currency is often divisible in smaller units. For example, Bitcoins are divisible, like the US dollar or euro into subunits (like pennies). There are other digital crypto-currencies that operate on the Bitcoin protocol, including LiteCoin and Dogecoin.

Bitcoins were launched in 2008, by a programmer known as Satoshi Nakamoto—a name believed to be an alias—posted a paper outlining Bitcoin's design and later in 2009 released software that can be used to exchange Bitcoins using the scheme described in the paper. That software is now maintained by an open-source community coordinated by developers.

The process of generating digital currency, like Bitcoins, involves solving complex algorithms and sharing the solution with the entire network. This “mining” process is very computationally intensive and requires powerful computers. Growth of the Bitcoin money supply is predefined by the Bitcoin protocol, and in this way inflation is kept in check. As of the filing date of this provisional application, there are over 12 million Bitcoins in circulation with an approximate creation rate of 25 Bitcoins every ten minutes. The total supply is capped at the arbitrary limit of 21 million, and every four years the creation rate is halved.

Transfer of digital currency involves the Bitcoin software performing a mathematical operation to combine one party's public key with one's own private key stating the amount of Bitcoins that are to be transferred. The result of that operation is then sent out across the distributed Bitcoin network so the transaction can be verified by Bitcoin software clients not involved in the transfer. This verification process involves the Bitcoin mining process described earlier for which the miners are rewarded with a preset quantity of Bitcoins.

Integral to Bitcoin is a public ledger, a database with a sequential record of all transactions, also known as the block chain, that records Bitcoin ownership at present and at all points in the past. By keeping a record of all transactions, the block chain prevents double-spending, a problem particular to digital money. The block chain provides only a certain level of anonymity as it identifies receivers by Bitcoin addresses rather than individuals' names.

Digital currency is currently transacted through various unregulated spot exchanges. There is considerable inter-day and intra-day price variation among prices at these exchanges. Digital currency prices have shown a much high degree of volatility influences by regulatory shocks, theft of digital currency, evolving demand and supply dynamics etc.

Options and futures contracts are generally known to try to help hedge the price risk faced by market participants. Successful contracts that attract significant participation facilitate low-cost execution of trades. The contract specifications must serve the interests of hedgers (those who use the contracts to manage their existing exposure to adverse price changes in the underlying commodity) and traders, including speculators, who provide market liquidity trading with the goal of profiting from price changes. Option and future contracts are used by hedgers primarily for the purpose of protecting against economic loss due to adverse price changes in the underlying commodity.

For futures contracts, the great majority of futures contract positions (buy-side “long” positions and sell-side “short” positions) are netted out before the contract reaches its denoted expiration date. This netting occurs through the initiation of a position that is opposite the one the account holder held as expiration approaches. Position holders that do not net out a long or short position before the futures contract expires become part of the delivery process. Those who stay “short” must deliver eligible instruments and those who remain “long” will be required to make payment and accept delivery.

A need therefore exists for an improved methods, systems and devices that will promote successful trading and delivery of option and future contracts for digital currencies.

### SUMMARY OF THE INVENTION

The invention relates to a method to facilitate trading of digital currencies, which comprises electronically storing an amount of a digital currency on an electronic registry or storage device; and physically storing the registry or storage device in a secure, physical repository that is not publicly accessible with the storage device available for use in subsequent delivery of the digital currency.

The method may include authenticating the storing of the registry or storage device in the repository to assure that the digital currency is legitimate. Furthermore, the registry or storage device is typically delivered to a clearing entity in advance of or in connection with a transfer of the digital currency to another entity to complete a trade.

The storage device is preferably provided with security protocols to limit access to the amount of digital currency therein to a limited number of authorized individuals that possess appropriate passwords. The electronic storage device is typically a Universal Serial Bus (USB), flash drive, portable drive or external hard drive, and the physical repository is a safe, storage chamber, storage locker, file, drawer, or other repository. The physical repository is advantageously provided with security features or security protocols to limit access to the amount of currency therein to a limited number of authorized individuals that possess appropriate passwords.

The invention also relates to a method for improving delivery during trading of digital currency which comprises providing a clearing entity with an electronic identification of an amount of digital currency that is available for trading by a holder of the digital currency, with the electronic identification substantiated by an electronic storage device that includes the amount of digital currency; trading contracts for the digital currency electronically through the clearing entity; and transferring an amount of digital currency from the holder to a buyer when the holder's contracts require such delivery. The amount of digital currency to be transferred is provided from the amount that is stored on the storage device, which is held in a secure, physical repository that is not publicly accessible.

Another embodiment of the invention relates to a method for trading of digital currency which comprises providing a clearing entity with an electronic identification of an amount of digital currency that is available for trading, with the electronic identification substantiated by an electronic registry that is maintained in a secure, physical repository that is not publicly accessible; trading contracts for the digital currency electronically through the clearing entity; and transferring an amount of digital currency from the holder to a buyer when the holder's contracts require such delivery, wherein the amount of digital currency to be transferred is provided from the amount that is provided on the electronic registry that is maintained in the secure, physical repository. The electronic registry typically holds Bitcoin quantities in or from a digital wallet or other electronic account.

The contracts may be option contracts, OTC or exchange traded, forward contracts, OTC or Exchange traded or futures contracts traded on a regulated exchange, and the amount of digital currency to be transferred is that which is due from the holder when the holder's contracts do not offset. The trading is generally conducted between digital currency holders that are listed on an electronic register that is established by the clearing entity or a designated central regulatory organization based on the credit worthiness or membership of the digital currency holder. Also, the secure, physical repository is maintained by the clearing entity or a financial institution.

The invention also relates to a computerized based method for facilitating trading of contracts for digital currency in an organized market environment, which comprises establishing participant accounts in a registry which is maintained by a clearing entity; conducting trades of contracts for the digital currencies between buyer and seller market participants: and crediting and debiting a quantity of digital currency from the participant accounts and electronically recording such transactions in the registry. This method manages exposure to price volatility in the market for digital currencies by providing low-cost, financially guaranteed transactions due to the availability of the digital currency on the seller's physical portable electronic device. As above, the digital currency in a seller's account is supported by a physical portable electronic device or an electronic registry that includes a quantity of digital currency stored in memory therein, wherein the electronic device or registry is held in a secure, physical repository that is not publicly accessible.

The contracts, typically options or futures contracts, are traded on an exchange platform associated with a computer network to an approved party who desires to acquire or sell the predefined quantity of the digital currency. The approved party will have a digital currency registry account established with the clearing entity, and physical delivery of the seller's physical portable electronic device or electronic registry that includes the appropriate quantity of digital currency therein will be made to the buyer when the contract is exercised. In this regard, the clearing entity has the sole ability for account management, recordation and monitoring of the registry account.

The buyer and seller market participants generally include natural hedgers, retail establishments, financial institutions, service providers who accept digital currencies as form of payment, suppliers of digital currency, or speculators who participate to assume price risks, while the clearing entity authenticates that the amount of digital currency is properly documented and is legitimate and the secure, physical repository is maintained by the clearing entity or a financial institution. When the physical portable electronic registry or device holds a quantity of digital currency that is greater than the amount traded, the clearing entity adjusts the quantity to the amount traded and transfers the greater amount to a second physical portable electronic device or registry.

The invention also relates to a computer-based system for facilitating trading of options contracts for digital currency in an organized market environment, which comprises a physical portable electronic device or registry that includes a quantity of digital currency stored in memory therein and a server. The electronic device or registry is held in a secure, physical repository that is not publicly accessible, and the server establishes participant accounts in an additional secure registry which is maintained by a clearing entity, wherein digital currency in a seller's account is supported by the physical portable electronic device or registry; conducts trades of options contracts for the digital currencies between buyer and seller market participants; and credits and debits a quantity of digital currency from the participant accounts and electronically recording such transactions in the further registry. This system manages exposure to price volatility in the market for digital currencies by providing low-cost, financially guaranteed transactions due to the availability of the digital currency on the seller's physical portable electronic device or registry.

### BRIEF DESCRIPTION OF THE DRAWINGS

FIG. 1 is a simplified block diagram of a trading system that may be used for trading option contracts for digital currencies according to the invention.

FIG. 2A provides a simplified diagram of a secure storage repository for the electronic storage device of the invention. Such infrastructure will facilitate trading of options and futures contracts of digital currency and is considered to be a unique contribution of this invention.

FIG. 2B provides a simplified diagram of the secure registry holding the digital currency. Such financial infrastructure will facilitate trading of contracts for digital currency and is considered to be a unique contribution of this invention.

FIG. 3 is a high-level functional block diagram of a system and network for implementing the systems and methods of the present invention.

FIG. 4 is a diagram of a functional block diagram illustrating an embodiment in which administration of the account and updating of transmitted market estimates to the account can be operated on different computer systems.

FIG. 5 is block diagram illustrating an exemplary cloud communications network.

FIG. 6 is a block diagram illustrating an exemplary cloud storage object.

FIGS. 7A and 7B present simplified block diagrams of a physical delivery system that may be used to in conjunction with a future or options market for digital currency according to method described in this invention. FIG. 7A presents the delivery process for call options while FIG. 7B presents the delivery process for put options.

FIG. 8 presents a simplified block diagram of a physical delivery system that may be used to in conjunction with a future market for digital currency according to method described in this invention.

### DETAILED DESCRIPTION OF THE INVENTION

The present invention relates to methods of facilitating trade of digital currencies in an organized market environment. The invention remedies the deficiencies of the prior art, and provide methods for promoting the trading of digital currency contracts. In particular, the method provided is a low-cost, financially guaranteed tool for managing exposure to price volatility in the market for digital currencies.

In an exemplary embodiment, the markets include options transactions in organized and regulated exchange environments. Participants could include natural hedgers such as retail establishments, financial institutions and other service providers who accept digital currencies as form of payment or suppliers, i.e., miners of digital currency. Other participants could include speculators who participate in such market to assume price risks.

The present invention also relates to a computer-based system for facilitating the trade of digital currencies. Such a system includes a method for accounting digital currencies in customer accounts, i.e., crediting and debiting a quantity of digital currency from customer accounts and recording such transactions. The method also includes conducting trades of the digital currencies between the market participants, and providing methods for physical delivery of digital currency to the buyer and funds to the seller.

One aspect according to the invention pertains to a process for promoting digital currency trading. The method includes creating a futures contract for digital currency for use by approved parties to trade digital currency, and selling the digital currency in an exchange platform associated with a computer network to an approved buyer who desires to acquire the quantity of the digital currency. A futures contract is a standardized contract between two parties to buy or sell a specified asset of quantity of digital currency for a price agreed upon today with delivery and payment occurring at a specified future date. Each futures contract on the digital currency will represent a standardized predefined quantity of a particular digital currency with specifications on its grade, deliverable quantity and location. In another advantageous implementation, the digital currency futures expire on a preset expiration date. To illustrate, the digital currency futures may be a quarterly contract or an annual contract.

One aspect of this invention pertains to creating options contracts for digital currency for use by approved parties to trade digital currency. Options contracts provide the right but not the obligation to buy or sell a quantity of digital currency. The present invention envisages both a call option on digital currency and a put option on digital currency. A call option on digital currency provides the holder with a right, but not the obligation, to purchase an agreed amount of digital currency at an agreed price. A put option on digital currency provides the holder with a right, but not an obligation, to sell an agreed amount of digital currency at an agreed price.

Under the invention, exercising the call options on digital currency will result in actual delivery of the digital currency through a physical portable electronic device (PPED) as specified by the exchange. Similar exercising a put option will require transferring digital currency either to an electronic registry or through a PPED to the buyer.

Another aspect of the invention, involves the options could be European style, American style or any other options termed as exotic options.

In one aspect, the invention relates to a method for promoting trading of contracts for digital currency. The method includes creating a mechanism for physical delivery of the digital currency for use by approved parties to trade digital currencies. This involves selling the digital currency to an approved buyer who desires to acquire the amounts of the digital currency in a physical device.

According to this implementation, an approved party is a clearing entity such as a clearing participant or trading party who has a digital currency registry account established with a designated central regulatory organization. The central regulatory agency may be a government regulatory entity or market regulatory entity such as an exchange or clearing house. In a variation, the parties are approved by a digital currency futures exchange based on predetermined criteria including at least one of creditworthiness and membership in the regulatory organization. The registry account typically holds Bitcoin quantities in or from a digital wallet or similar electronic account.

According to one embodiment, the method also includes physical delivery of the digital currency. Delivery of the instrument is preferably facilitated by a clearing service provider. Typically, delivery will occur over three consecutive business days. The business days can include a position day, a notice day and a delivery day. Physical delivery can be accomplished by delivery of a PPED that holds a quantity of digital currency from the seller to the buyer. The transfer of digital currency between the buyer and seller is mediated and tracked by respective clearing service provider and the exchange.

In one embodiment, the PPED utilized for the holding the digital currency and making physical delivery feasible includes a Universal Serial Bus (USB), a flash drive, a portable drive, an external hard drive etc. The PPEDs hold the pre-specified quantity and type of digital currency. These devices include built in security features that are intended to prevent theft, hacking and general loss of data. These security features could include biometric identification, passwords, security tokens, or other codes. Multiple layers of security features may also be imposed in a sequence to enhance security. Examples of biometric identification include recognition of the fingerprint, face, or palm veins, palm prints, iris and retina. Other features may include behavior pattern including typing attributes, gait and voice recognition features.

In yet another embodiment, the PPEDs described above are housed within a physical vault. In such cases, the PPEDs are held in individual and secure physical vaults of the buyer, seller and their provider of clearing services. Approved entities overseeing the physical delivery process are charged with physically transferring the PPEDs from one account to the other and recording the transactions.

In another aspect, the invention relates to a method for promoting digital currency futures contracts trading. The method includes creating a mechanism for physical delivery of the digital currency for use by approved parties to trade digital currencies. This involves selling the digital currency to an approved buyer who desires to acquire the amounts of the digital currency from a secure registry, i.e., one that is maintained in a secure physical repository.

According to the invention, the physical vaults may be a safe, storage chamber, storage locker, file, drawer, or other repository that includes appropriate security features to prevent access to the vault by non-authorized persons of the clearing entity. These security features could include combination locks, biometric identification, passwords, security tokens, or other codes. As above, multiple layers of security features may also be imposed to enhance security. Examples of biometric identification include recognition of the fingerprint, face, or palm veins, palm prints, iris and retina. Other features may include behavior pattern including typing attributes, gait and voice recognition features. In this way, the PPED or registry is maintained in a secure manner until access, modification or delivery of the digital currency is required, at which time the clearing entity will retrieve and deliver the appropriate amounts.

When the holder's PPED or registry account holds more digital currency than needs to be delivered, the clearing entity will make the appropriate allocation and update the PPED or registry with the remainder. For the transfer of the PPED, the clearing entity can create a new PPED with the amount to be transferred. Alternatively, the clearing entity can create a new PPED with the remaining balance and transfer the existing PPED to the buyer.

A preferred embodiment of the present invention relates to providing improved processes or systems for clearing such transactions and providing a trusted infrastructure behind such trading. In some embodiments, the register is a standalone database which can include an associated computer. The database is not connected to any networks, such as LANs, WANs, cellular networks, or near field networks. The database and its associated computer does not have physical or wireless communications connections to other computers or devices such mobile devices, routers, and servers. The database is implemented to provide the ability to add Bitcoins (or generally speaking any other digital currency) to the register only through electromechanical ports (e.g., USB), drives, or input means. The database is disconnected from networks in order to secure the data from potential hacking or unauthorized access to the digital currency in the register. The database and its associated computer can have software onboard for providing additional security such as for performing virus scans on USBs or other media to prevent a worm or other virus to cause damage to the database or computer.

When at the conclusion of trade transaction, the digital currency is required, the digital currency is removed from the database using electronic media such as USB and delivered to a system that will handle the associated transfer transaction. The database and electronic medium are preferably under physical security such as by being located within the same building under physical security protocols. Physical security can be a physical storage vault for the electronic register as well as other options.

The database will include information identifying associated users who deposited the digital currency in the register. The database and associated computer will include software including an interactive interface that permits users to view the current state of digital currency holdings for each user and if desired, perform an automatic operation to move an amount of digital currency from the database to an electronic medium (for the purpose of carrying the medium to another machine that is connected to a network such a LAN, WAN, or the Internet).

In some embodiments, when a user deposits an amount of digital currency with the register, the deposit will be reflected in a BlockChain that is included in a public ledger. The deposit can be recorded as being a transfer of the digital currency form the owner/user to the register (the clearing system/clearing company). This is one way of implementing an escrow or deposit of digital currency by actually transferring “ownership” to the clearing company. At the completion of the trade, the transfer of digital currency is performed using private information (e.g., the public and private keys of counterparty clearing firms) of the clearing companies that are associated with the trade.

According to this implementation, an approved party is a clearing entity such as a clearing participant or trading party who has a digital currency registry account established with a designated central regulatory organization. The central regulatory agency may be a government regulatory entity or market regulatory entity such as an exchange or clearing house. In a variation, the parties are approved by a digital currency futures exchange based on predetermined criteria including at least one of creditworthiness and membership in the regulatory organization.

According to one embodiment, the method also includes physical delivery of the digital currency. Delivery of the instrument is preferably facilitated by a clearing service provider. Typically, delivery will occur over three consecutive business days. The business days can include a position day, a notice day and a delivery day. Physical delivery can be accomplished by electronic delivery of digital currency between the seller and buyer electronic registry accounts. The transfer of digital currency between the buyer and seller is mediated and tracked by respective clearing service provider and the exchange.

In one embodiment, the designated electronic registry for digital currency is housed within a physical vault. The electronic registry has individual accounts for the buyer and seller and their providers of clearing services. Preferably the electronic registries are not be connected to the internet to prevent unwarranted access to the user accounts. Approved entities may selectively access the electronic registries for purposes of account management, recordation and monitoring.

In another embodiment, the method further includes releasing payment to a seller after confirmation is received that a buyer has physically received the digital currency from a central regulatory agency in buyer's account. The method also preferably includes receiving reports of transfers of all or a portion of the digital currency. Monitoring, recording and approving at least one of all transfers and redemption of the digital currency is advantageously included in the method.

The history of futures and options contract designs suggests that that trading is more active when the needs of market participants are adequately fulfilled. Contract specifications need to include features that make the futures and options contract relevant and reliable to a wide range of hedgers and traders. In addition, provisions must be included that encourage trade by allowing traders to profit from unique specifications relating to deliverable instruments and time period allowed for election to take or make delivery. To assure the contracts are useful for hedgers, contract terms must allow for a degree of convergence of prices of the underlying cash market instrument and prices of the associated options contract. The balancing among these sometimes competing considerations is critical to establish a successful new options market for digital currencies.

Digital currency, as used herein, is intended to mean and include any digital crypto-currency, such as Bitcoin, LiteCoin, Dogecoin and the like.

Specifications for implementation of a digital currency options contract would include items such as contract size, quotation, strike price, minimum price or tick increment, trading hours, delivery months, first and last trading day, settlement price calculation, deliverable instruments, delivery process, price limits, reportable position limits, and nearby expiration month speculative position limits.

In the case of digital and intangible commodities such as digital currencies, while the obvious specification for a options contract would allow for delivery of digital currency electronically, the present invention allows for delivery of digital currency in a physical format. Thereby, the present invention provides means for accepting delivery in tangible form a digital currency.

Settlement prices may be based, for example, on the following criteria: (a) a single traded price during the pre-close: (b) if more than one trade occurs during the pre-close, the trade volume weighted average of the prices, rounded to the nearest tick: (c) if no trade occurs during the pre-close, the volume weighted average of the last two trade prices; and (d) if there are no trades, the price midway between the best bid and offer (volume weighted) at the end of the pre-close rounded to the nearest tick. The exchange authority may reserve the right to take into account other factors in determining settlement prices, e.g., spread differentials between the contract months.

Approved entities may create and trade options contracts with other approved entities. In one embodiment, clearing participants and parties trading in the market will have a digital currency electronic registry account established with the designated regulatory body. In another embodiment, clearing participants and parties trading in market will have an account in a physical vault established with the designated regulatory body. As discussed in more detail below, there are delivery procedures that must be followed according to a clearinghouse and the regulator.

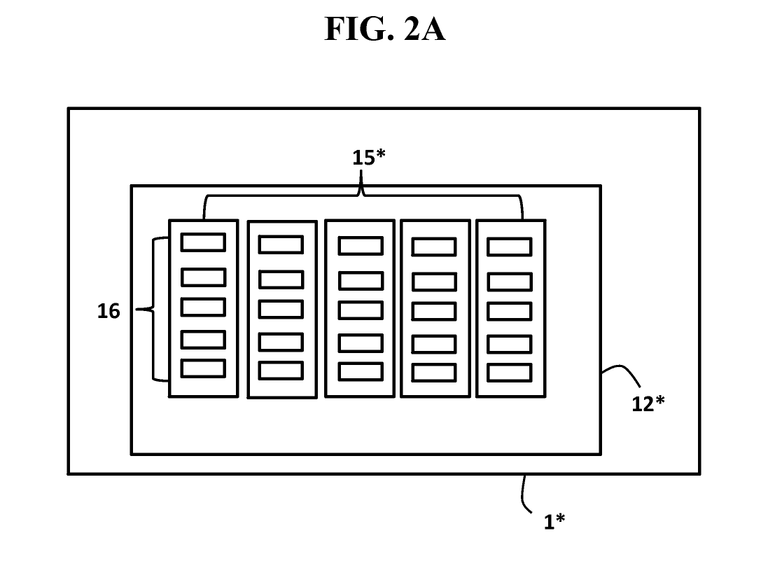

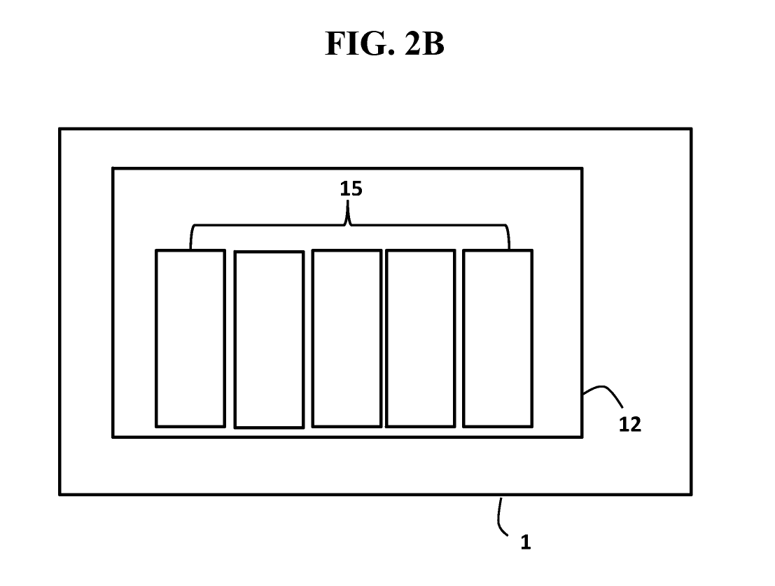

The present invention provides delivery of the digital currency held in designated PPEDs or electronic registries in physical vaults held by the buyer and seller. The delivery process may involve the following sequence of events as set forth in FIGS. 2A and 2B.

Delivery is typically a three day process consisting of Position Day. Notice Day and Delivery Day. The three days generally occur over three consecutive business days.

An exchange pre-determined trading day, for example tenth day, prior to a contract's expiration (expiration occurring after the close on the final trading day) is the first day that clearing members must report their Long Call or Short Put positions in the expiring contract. This day is termed Position Day. The Long Call or Short Put positions as of the close of business on the tenth trading prior to expiration, by trade date, must be reported to the Clearing Service Provider (CSP) in the time frame and format required by the CSP. Starting on the First Position Day, seller clearing members on behalf of their Short Call or Long Put options position holders may submit delivery tender notices to the CSP in a format acceptable to the CSP.

On the business day after the delivery tender notice has been submitted and the delivery assignment made by the CSP, the seller clearing member provides to the buyer clearing member(s) the intent of delivering the digital currencies. This day is termed Notice Day. The buyer clearing member(s) provides electronic registry account or physical vault account information to the seller clearing member. Information exchange is generally to be completed by a certain time, for example, 4:00 p.m. Central Time. The seller clearing member must typically have the appropriate digital currencies deposited in the electronic registry account or PPEDs deposited in the physical vault by a certain time, for example, 5:00 p.m. Central Time.

During the morning of the next day at, for example, 6:40 a.m. Central Time, the CSP will issue payment instructions to the respective buyer clearing members for the full contract value based upon the Position Day's settlement price in a means and manner prescribed by the CSP. By another time, for example, 10:00 a.m. Central Time, the seller clearing member must electronically submit instructions for transfer of the PPEDS or electronic registries into the physical vault. The seller clearing member must then forward the confirmation instructions to the CSP as verification that the delivery has been completed.

After delivery is completed, the CSP releases the delivery proceeds to the seller clearing member on the following exemplary schedule. If the delivery confirmation is received by the CSP prior to 12:45 p.m. Central Time, the proceeds are released on the same day in the mid-day variation cycle. If the delivery confirmation is received by the CSP after 12:45 p.m. Central Time, the proceeds are released on the next business day through the 6:40 a.m. Central Time settlement cycle.

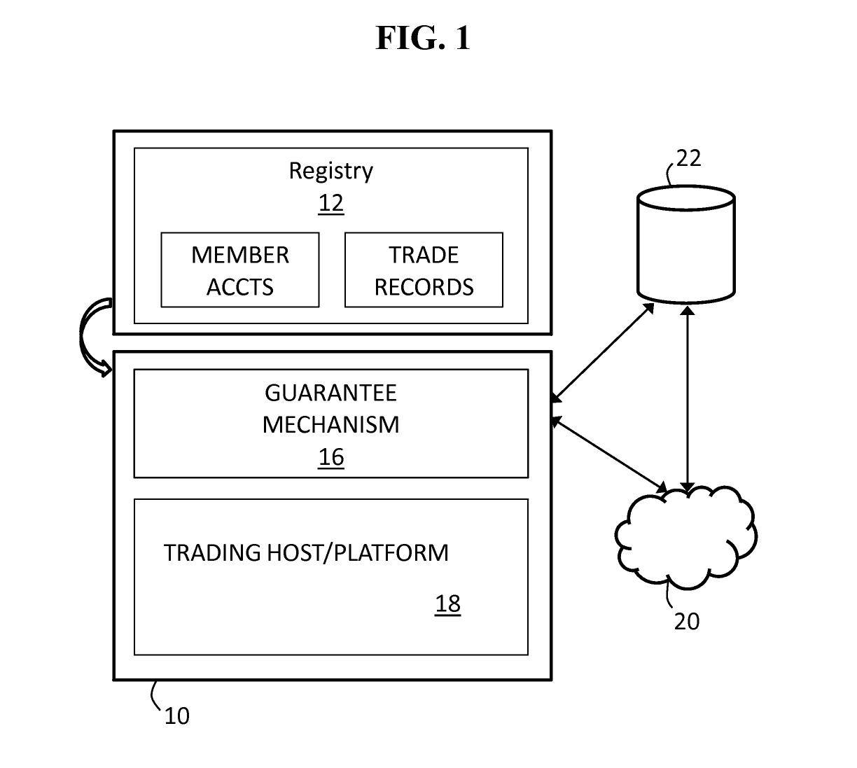

FIG. 1 is a simplified block diagram of an trading system for digital currency 10 that may be managed by a digital currency options exchange. The exchange promotes trading by, for example, approving parties based on predetermined criteria including at least one of creditworthiness and membership in a regulatory organization.

The system 10 can include an registry 12, a guarantee mechanism 16, and a trading host or platform 18. The system 10 can be coupled to a network 20, such as the Internet or any other public or private network or connections of computing devices. The system 10 can be communicatively coupled to an transaction database 22, either directly or via the network 20.

In an embodiment, a portion of the registry 12 serves as the official record of the digital currency options transactions of each participant or entity in the commodity market managed by the system 10. Sales or trades of the digital currency options become officially acknowledged for compliance purposes only when they are reported by the buyer and by the seller to the registry 12. The registry 12 can also hold types of digital currency, such as Bitcoins, Doge coins, Lite coins etc. Each of these digital currencies is held in different accounts.

The guarantee mechanism 16 enhances market performance by ensuring that those who conduct sales of digital currency on the trading platform 18 receive next-day payment even if the buyer fails to execute the payment process. This mechanism allows for anonymous trading by eliminating the need to address the credit worthiness of buyers. Non-payment risk is eliminated, thus removing a transaction cost. This feature allows the participation in trading by liquidity providers (including “market makers”), who can stand ready to promptly buy and sell. The presence of standing buyers and sellers increases trading activity, which improves the economic efficiency of the price discovery process. In addition, the ability to trade anonymously allows members to post bids and offers and execute trades without revealing their trading strategies. The guarantee mechanism 16 eliminates the risk that a buyer may fail to make payment.

The trading platform 18 is an electronic mechanism for hosting market trading that provides participants with a central location that facilitates trading, and publicly reveals price information. The trading platform 18 reduces the cost of locating trading counter parties and finalizing trades, an important benefit in a new market.

The registry 12 may be a physical registry or an electronic registry. FIG. 2A presents a physical registry 12* that may be held within a physical vault 1*. The physical registry 12* may further contain individual vaults 15* for each account holder. Each of the individual vaults 15* contains a designated PPED 16* or multiple designated PPEDs 16* that contain the digital currency. Transfers from individual account 16* to another are done manually by an authorized entity. The authorized entity removes one or more PPEDs in one individual vault and places them into another individual vault when a trading or transaction occurs. Transfers from individual account 16* to another may also be done automatically when the physical registry 12 includes computer systems and mechanical mechanisms that perform such function. For example, the computer systems may have a display mounted on a wall of the physical registry 12 for entering the account number (or the number of the individual vault) from which the PPEDs are retrieved and the account number (or the number of another individual vault) to which the PPEDs are delivered. The computer systems may have a hardware that communicates with the mechanical mechanisms to perform the retrieval and delivery upon entering the above account numbers.

FIG. 2B shows an electronic registry 12 that is held within a physical vault 1. The electronic registry 12 may further contain individual electronic accounts 15, as opposed to individual physical vaults, in the physical registry 12*, to house the digital currency for the various market participants. These accounts are not connected to one another and any transfer should be done manually by an authorized entity. The electronic registry 12 is not connected to the internet for security purposes.

In one embodiment, the electronic registry 12 may have a plurality of storage mediums or memories with each dedicated to only one individual electronic account for storing and updating the digital currency of that account. For example, the electronic registry 12 has memories A, B, and C with each dedicated to account X, Y, and Z, respectively. Memory A stores only the balance of account X, and a change in the balance of account X would only update memory A.

In another embodiment, the electronic registry 12 may have a plurality of storage mediums or memories with each associated to multiple electronic accounts. Each memory stores a portion of the total balance of each electronic account and a change in the total balance of an electronic account may update one or more memories. For example, the electronic registry 12 has memories D, E, and F, and accounts U, V, and W each with 300 Bitcoins are evenly stored among memories D, E, F. As such, each of memories D, E, and F contains 300 Bitcoins with 100 in each memory belonging to each of accounts U, V, and W (memory D contains 300 Bitcoins with 100 belonging to account U, 100 belonging account V, and 100 belonging to account W, memory E contains 300 Bitcoins with 100 belonging to account U, 100 belonging account V, and 100 belonging to account W, and memory F contains 300 Bitcoins with 100 belonging to account U, 100 belonging account V, and 100 belonging to account W). When there is a change in the total balance of an account, such as a payment of 100 Bitcoins from account U, the payment may be made from only memory D with the 100 Bitcoins belonging to account U or from both memories D and E with 50 Bitcoins belonging to account U from each memory.

While the above example shows that the Bitcoins are evenly distributed among the memories, the Bitcoins may also be unevenly divided. When multiple memories are utilized to store the total balance of an account, the electronic registry 12 may be configured to calculate the total balance of the account by first accessing each memory to obtain a partial balance associated with that account and then adding all the partial balances obtained.

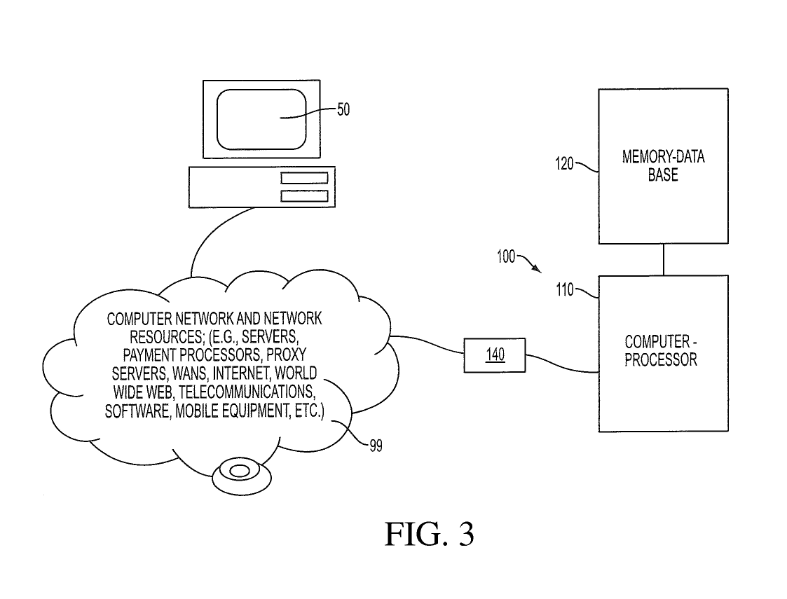

FIG. 3 illustrates computer system 100, which may comprise computer processor 110 having one or more central processing units, and non-transient memory 120 for storing data and software. Computer system 100 is configured to carry out the steps encoded in software instructions for manipulating the data regarding the information that is provided on the storage unit or in the registry and for storing that data in memory 120. The computer system may further comprise transient memory, for example, RAM, for processing the data and instructions, and peripherals such as displays, printers, keyboards, mice, and interface devices known to those in the computer arts. Memory 120 can be an internal or external database. If desired, one or more computers and storage systems can be used to assist the server device in implementing the overall processing and operation of the computer system 100.

A general purpose system may encounter problems with managing large amounts of data regarding the plurality of storage mediums or memories that are in the electronic registry and that are each associated to multiple electronic accounts. To handle the number of accounts and plurality of storage mediums or memories and to assure that the accounts include the proper entries without duplications or separation of data over disconnected storage sites, the system is advantageously configured to use a unique identification code for each stored electronic account. Furthermore, to avoid the possibility of inadvertently created duplicate records, the system could also be configured to search the system storage for the identification code to confirm that the record(s) used to maintain the data values of a particular account exists in the system and are the proper record(s) for the specific account. The system may be configured to require the account holder to also utilize the identification code when transmitting or receiving information for security purposes.

The information relating to the electronic account can be entered into computer system 100 through an interface and stored in database 125. Database 125 may be, for example, a relational, hierarchical, object-oriented, network, or correlation database. The database may be localized on a single machine or distributed over multiple machines at the same or different locations.

Communication hardware 140 allows the computer system 100 to transmit and receive data over communication lines connected to one or more networks, which may be for example, the Internet, LAN, WAN, and MAN networks, telecommunication networks, satellite networks, and/or wireless networks. Communication hardware 140 may handle the packetizing or depacketizing of data and handle protocol requirement necessary for transmitting and receiving packets. Communication hardware 140 can transmit or receive data or information to or from computer system 100, which it is serving.

Problems may be encountered by general computing systems with delays in communication of transaction and account data between various disperse system components. To handle the volume of data communicated from multiple physical localities at essentially the same time, the system should have a sufficient capacity of parallel communication channels that can both receive the expected volume of data from transactions, identify the correct hardware installations and/or components where the corresponding data records are stored, and transfer the data to the correct computer system component(s) for calculation and record updating, all in a timely manner. Transmissions to the system 100 through the communication hardware 140 may comprise addresses identifying the correct hardware installations and/or components where the corresponding data records are stored.

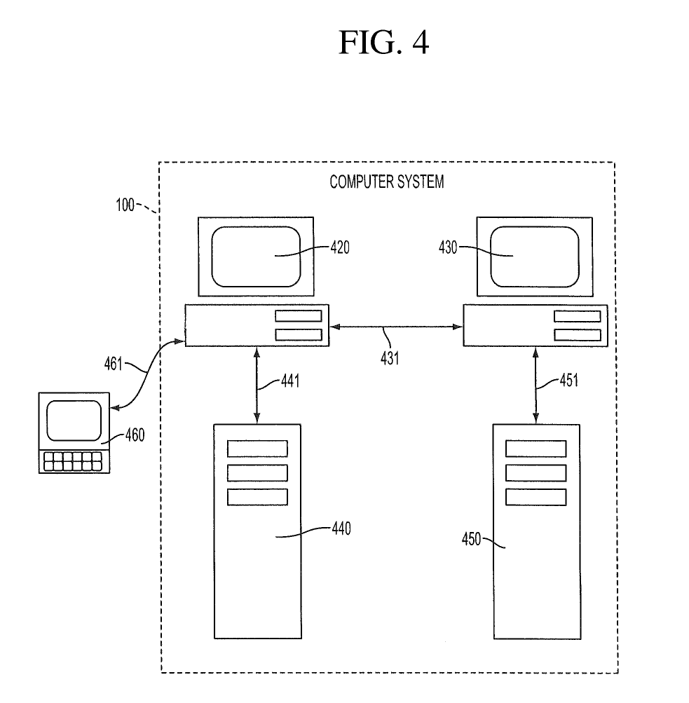

In some embodiments, a system and method can be implemented that divide the storage and administration of account information between two entities or systems. For example, a first entity or system can be responsible for creating and administering the institution account while another entity can be responsible for storing the transmitted market values and updating of the account to include that information. An illustrative embodiment of this arrangement is shown in FIG. 4, wherein computer system 100 can include multiple computer systems 420, 430 that communicate with each other and with one or more other devices 440, 450 that are remote from the computer system 100 over data communications lines. The data communications can be used for sending and receiving data related to account to the account holder and a purchaser or seller for updating the accounts with the amounts transferred.

Problems with maintaining and managing multiple diverse records at the same time may arise, such that an embodiment of the system could be configured to identify all of the accounts, storage records, and transactions as belonging to the same account regardless of where the information is being communicated or stored. This may be accomplished by an application and one or more identification table(s) that assigns the unique identification code when an account is created and stores the identification code with at least a portion of the record storage addresses in other components of the system 420, 430 associated with the account. Data communications could also include the address of the component of the system 420, 430 intended to receive the data. Backup records stored on separate systems could also be identified by their addresses and stored in the identification table(s).

In another embodiment, use of a single look-up table in a central, accessible, location containing storage addresses could allow coordination of data storage across all components 420, 430, 440, 450 of a system by identifying the correct information with the correct account, flagging a record as being updated by a transaction, and locking access to other associate records by other system components until updating of a record is complete.

Computer system 100 may comprise separate computer(s) 420 for opening and administering the Bitcoin accounts, and separate computer(s) 430 for updating the seller or buyer accounts. Computer(s) 420 and computer(s) 430 can communicate over a data line 431 (e.g., wired, wireless, WAN, LAN, Internet, etc.). These computers may also be in communication with one or more database servers 440, 450 over data communication lines 441, 451 for storage and retrieval of historical or backup data for the institution accounts.

Computer system 100 may further comprise communication hardware 140 that could be integral with one of the computers e.g., 420, or hardware separate from any particular computer, that connects computer system 100 over one or more communication line(s) 461 to remote devices 460. Remote devices 460 can include a user interface for the account holders. Computer system 100 is configured to send information to the remote device 460 to display account information to the institutions and to receive information regarding the transmittal of such data.

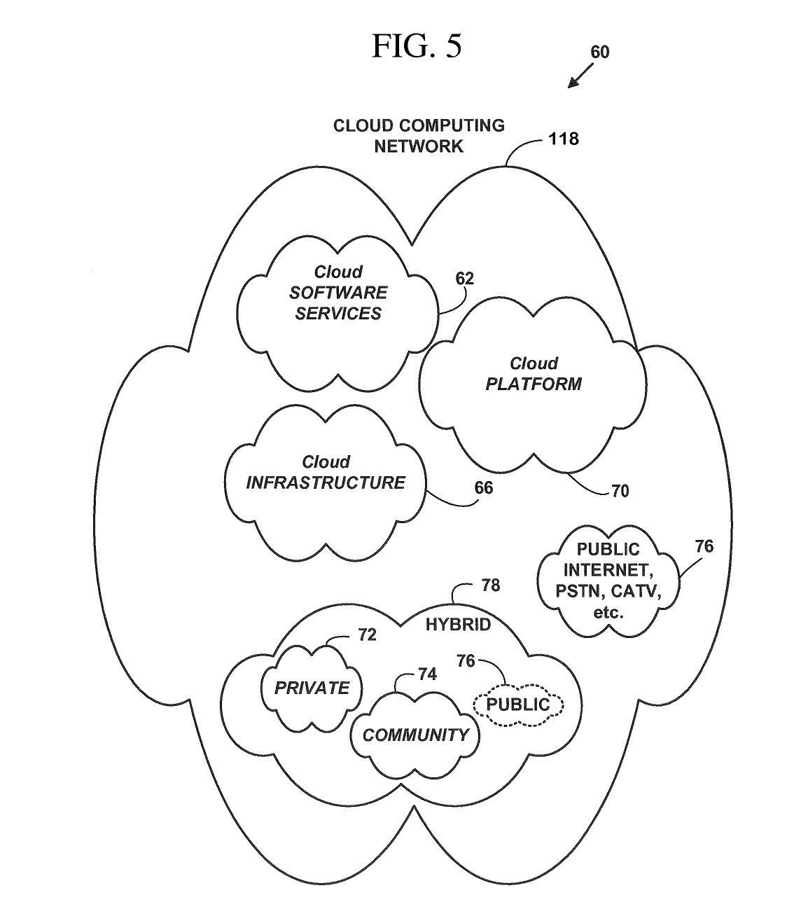

FIG. 5 is a block diagram 60 illustrating an exemplary cloud computing network 118. The cloud computing network 118 is also referred to as a “cloud communications network” 118. However, the present invention is not limited to this cloud computing model and other cloud computing models can also be used to practice the invention. The exemplary cloud communications network includes both wired and/or wireless components of public and private networks.

In one embodiment, the cloud computing network 118 includes a cloud communications network 18 comprising plural different cloud component networks 72, 74, 76, 78. “Cloud computing” is a model for enabling, on-demand network access to a shared pool of configurable computing resources (e.g., public and private networks, servers, storage, applications, and services) that are shared, rapidly provisioned and released with minimal management effort or service provider interaction.

Cloud computing or cloud communication is desirable for conducting trades of contracts and crediting and debiting of digital currency. The trading is preferably conducted on an exchange platform associated with a computer network. In particular, the option contracts or futures contracts disclosed herein can be traded through cloud communication with the amount to be transferred that which is due from the holder when the holder's contracts do not offset. Also, the trading can be conducted through cloud communication between digital currency holders that are listed on an electronic register that is established by the clearing entity or a designated central regulatory organization based on the credit worthiness or membership of the digital currency holder.

This exemplary cloud computing model for electronic information retrieval promotes availability for shared resources and comprises: (1) cloud computing essential characteristics; (2) cloud computing service models; and (3) cloud computing deployment models. Exemplary cloud computing essential characteristics include the following:
Broadband network access. Electronic registry data are available to Bitcoin account holders over plural broadband communications networks and accessed through standard mechanisms that promote use by heterogeneous thin or thick client platforms (e.g., mobile phones, smart phones, tablet computers, laptops, PDAs, etc.). The broadband network access includes high speed network access such as 3G and/or 4G wireless and/or wired and broadband and/or ultra-broad band (e.g., WiMAX, etc.) network access.
Resource pooling. Examples of pooled resources include storage, processing, memory, network bandwidth, virtual server network device and virtual target network devices.
Measured Services. Cloud computing systems automatically control and optimize resource use by leveraging a metering capability at some level of abstraction appropriate to the type data service (e.g., calculating, processing, bandwidth, custom electronic market estimators applications, etc.). Electronic market estimation calculation usage is monitored, controlled, and reported providing transparency for both the electronic market estimator calculations and the electronic market estimation information providers of the utilized electronic market estimators service.

Exemplary cloud computing service models illustrated in FIG. 5 follow. These include:
Cloud Computing Software Applications 62 and the capability to use the provider's applications running on a cloud infrastructure 66. The cloud computing applications 62, are accessible from the server network device from various client devices through a thin client interface such as a web browser, etc. The user does not manage or control the underlying cloud infrastructure 66 including network, servers, operating systems, storage, or even individual application capabilities, with the possible exception of limited user-specific application configuration settings.
Cloud Computing Infrastructure 66 with the capability provided to the user to provision processing, storage and retrieval, networks 118, 72, 74, 76, 78 and other fundamental computing resources where the consumer is able to deploy and run arbitrary software, which can include operating systems and applications. The user does not manage or control the underlying cloud infrastructure 66 but has control over operating systems, storage, deployed applications, and possibly limited control of select networking components (e.g., host firewalls, etc.).
Cloud Computing Platform 70 that provides the capability to the user to deploy onto the cloud infrastructure 66 created or acquired applications created using programming languages and tools supported servers, etc. The user not manage or control the underlying cloud infrastructure 66 including network, servers, operating systems, or storage, but has control over the deployed applications and possibly application hosting environment configurations.

Exemplary cloud computing deployment models are provided below. These include:
Private cloud network 72. The cloud network infrastructure is operated solely for electronic market estimation calculations It may be managed by the electronic content retrieval or a third party and may exist on premise or off premise.
Community cloud network 74. The cloud network infrastructure is shared by several different organizations and supports a specific electronic market estimation content community that has shared concerns (e.g., mission, security requirements, policy, compliance considerations, etc.). It may be managed by the different organizations or a third party and may exist on premise or off premise.
Public cloud network 76. The cloud network infrastructure such as the Internet, PSTN, SATV, CATV, Internet TV, etc. is made available to the general public or a large industry group and is owned by one or more organizations selling cloud services.
Hybrid cloud network 78. The cloud network infrastructure 66 is a composition of two and/or more cloud networks 118 (e.g., private 72, community 74, and/or public 76, etc.) and/or other types of public and/or private networks (e.g., intranets, etc.) that remain unique entities but are bound together by standardized or proprietary technology that enables data and application portability (e.g., cloud bursting for load-balancing between clouds, etc.).

The foregoing embodiments of the present invention are not limited to these particular characteristics, service models and deployment models, and more, fewer or other characteristics, service models or deployment models can also be used to practice the invention.

Cloud software 64 for electronic market trading of Bitcoin takes full advantage of the cloud paradigm by being service oriented with a focus on statelessness, low coupling, modularity, and semantic interoperability for electronic content retrieval.

Cloud storage of desired electronic content on a cloud computing network includes agility, scalability, elasticity and multi-tenancy. Although a storage foundation may be comprised of block storage or file storage such as that exists on conventional networks, cloud storage is typically exposed to requesters of desired electronic content as cloud objects.

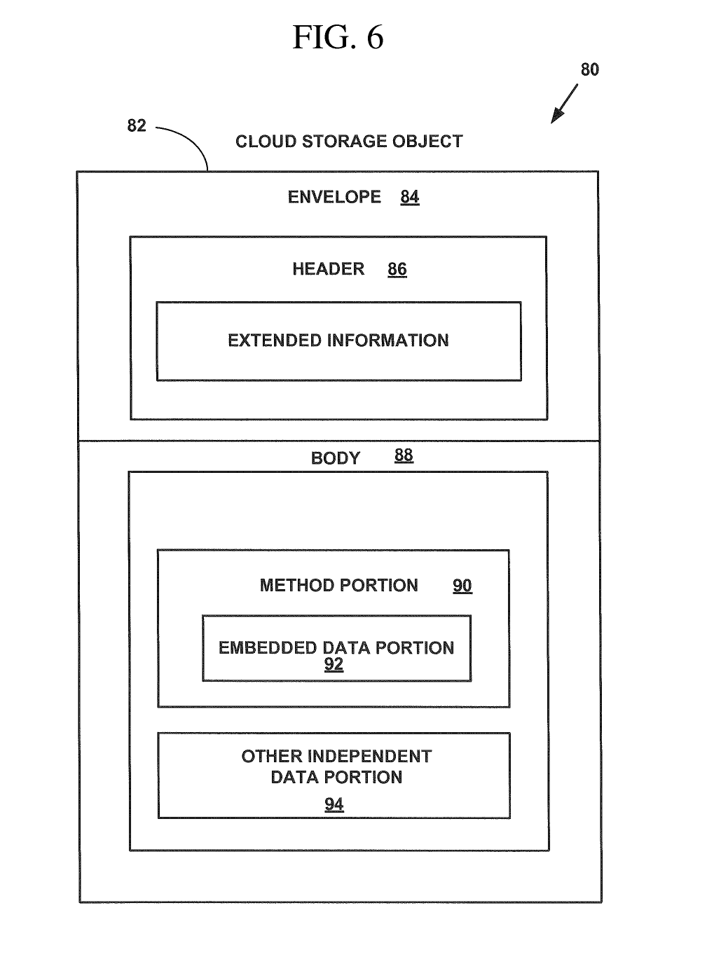

FIG. 6 is a block diagram 80 illustrating an exemplary cloud storage object 82. The cloud storage object 82 preferably includes an envelope portion 84, with a header portion 86, and a body portion 88. The envelope portion 84 uses unique namespace Uniform Resource Identifiers (URIs) and/or Uniform Resource Names (URNs), and/or Uniform Resource Locators (URLs) unique across the cloud communications network 118 to uniquely specify, location and version information and encoding rules used by the cloud storage object 82 across the whole cloud communications network 118. For more information, see IETF RFC-3305, Uniform Resource Identifiers (URIs), URLs, and Uniform Resource Names (URNs), the contents of which are incorporated by reference.

The envelope portion 84 of the cloud storage object 82 is followed by a header portion 86. The header portion 86 includes extended information about the cloud storage objects such as authorization and/or transaction information, etc. The body portion 88 includes methods 90 (i.e., a sequence of instructions, etc.) for using embedded application-specific data in data elements 92. The body portion 88 typically includes only one portion of plural portions of application-specific data 92 and independent data 94 so the cloud storage object 82 can provide distributed, redundant fault tolerant, security and privacy features described herein.

Cloud storage objects 82 have proven experimentally to be a highly scalable, available and reliable layer of abstraction that also minimizes the limitations of common file systems. Cloud storage objects 82 also provide low latency and low storage and transmission costs. In particular, the cloud storage objects 82 of the present invention include details of trading of options and futures contracts as well as the amounts of Bitcoin that were transferred when the holder's contracts do not offset.

Cloud storage objects 82 are comprised of many distributed resources, but function as a single storage object, are highly fault tolerant through redundancy and provide distribution of desired electronic content across public communication networks 76, and one or more private networks 72, community networks 74 and hybrid networks 78 of the cloud communications network 118. Cloud storage objects 82 are also highly durable because of creation of copies of portions of desired electronic content across such networks 72, 74, 76, 78 of the cloud communications network 118. Cloud storage objects 82 includes one or more portions of desired electronic content and can be stored on any of the 72, 74, 76, 78 networks of the cloud communications network 18. Cloud storage objects 82 are transparent to a requester of desired electronic content and are managed by cloud applications.

In one embodiment, cloud storage objects 82 are configurable arbitrary objects with a size up to hundreds of terabytes, each accompanied by with a few kilobytes of metadata. Cloud objects are organized into and identified by a unique identifier unique across the whole cloud communications network 118. These cloud storage objects 82 present a single unified namespace or object-space and manages desired electronic content by user or administrator-defined policies storage and retrieval policies. Cloud storage objects includes Representational state transfer (REST), Simple Object Access Protocol (SOAP), Lightweight Directory Access Protocol (LDAP) and/or Application Programming Interface (API) objects and/or other types of cloud storage objects.

REST is a protocol specification that characterizes and constrains macro-interactions storage objects of the four components of a cloud communications network 118, namely origin servers, gateways, proxies and clients, without imposing limitations on the individual participants.

SOAP is a protocol specification for exchanging structured information in the implementation of cloud services with storage objects. SOAP has at least three major characteristics: (1) Extensibility (including security/encryption, routing, etc.); (2) Neutrality (SOAP can be used over any transport protocol such as HTTP, SMTP or even TCP, etc.), and (3) Independence (SOAP allows for almost any programming model to be used, etc.).

LDAP is a software protocol for enabling storage and retrieval of electronic content and other resources such as files and devices on the cloud communications network 18. LDAP is a “lightweight” version of Directory Access Protocol (DAP), which is part of X.500, a standard for directory services in a network. LDAP may be used with X.509 security and other security methods for secure storage and retrieval. X.509 is public key digital certificate standard developed as part of the X.500 directory specification. X.509 is used for secure management and distribution of digitally signed certificates across networks.

An API is a particular set of rules and specifications that software programs can follow to communicate with each other. It serves as an interface between different software programs and facilitates their interaction.

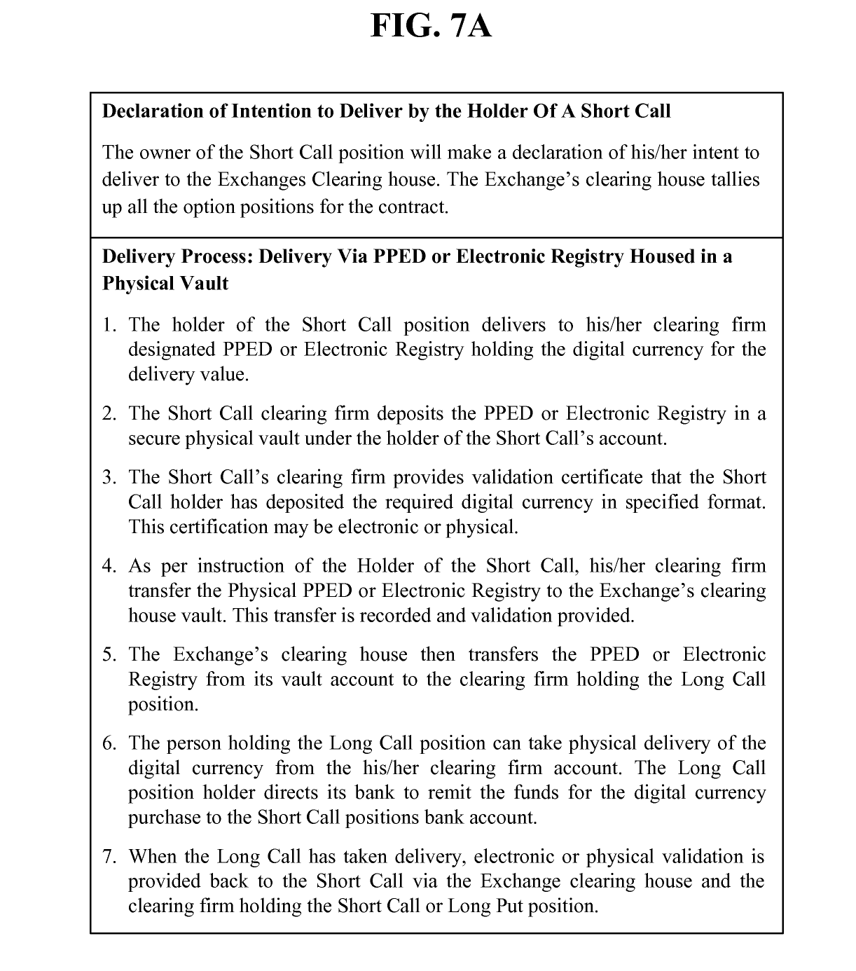

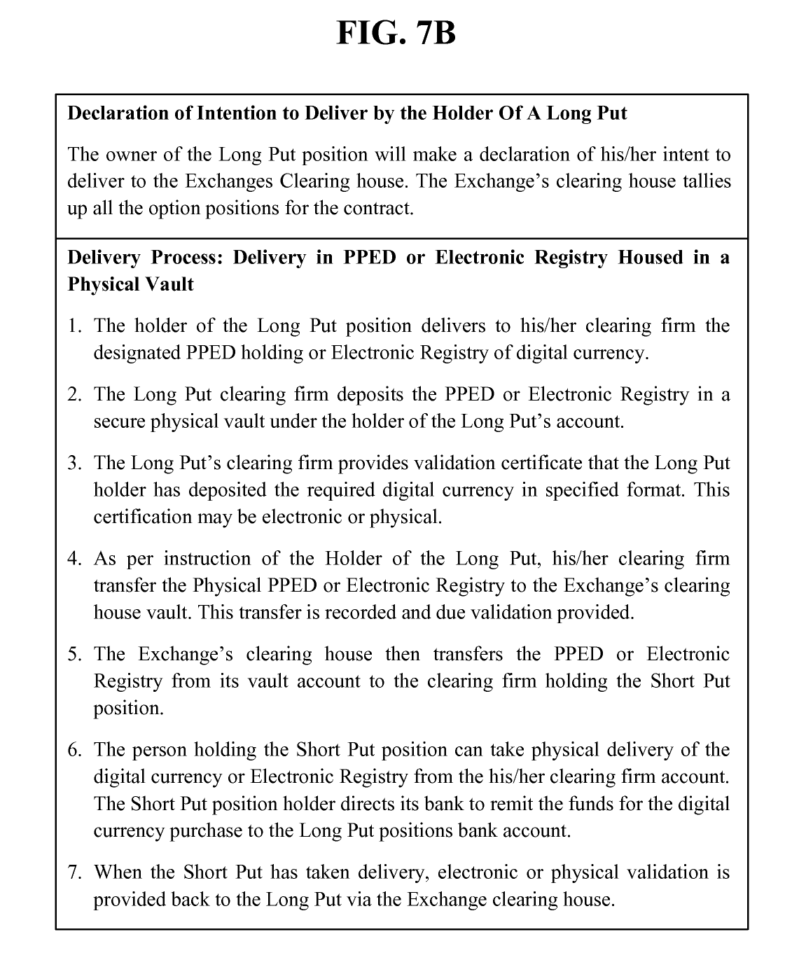

FIGS. 7A and 7B describe the various delivery alternatives presented as unique in this invention. These delivery alternatives include a novel means of delivering the digital currency in physical form.

In one option, the delivery process involves physical delivery of digital currency using PPEDs into physical vaults held by the market participants. The delivery process varies for Futures and options contracts are explained below.

Futures Delivery Process

The delivery process involves physical delivery of digital currency using PPEDs or electronic registries into physical vaults held by the market participants. Under this method, the first step involves declaration of the intention to deliver by the short position. Here, the owner of the short position will make a declaration of his/her intent to deliver to the Exchanges clearing house. The Exchange's clearing house tallies up all the long and short positions for the futures contract.

In step 2 of the delivery process, the holder of the Short position delivers to his/her clearing firm designated PPED or electronic registry holding the digital currency for the delivery value. The Short's clearing firm deposits the PPED or electronic registry in a secure physical vault under the Short's account. The short's clearing firm provides validation certificate that the short has deposited the required digital currency in a specified format. This certification may be in form of an electronic or physical device. As per instruction of the Short, the short's clearing firm transfer the physical PPED or electronic registry to the Exchange's clearing house vault. This transfer is recorded and due validation is provided by the short's clearing firm. The Exchange's clearing house then transfers the PPED or electronic registry from its vault account to the clearing firm holding the Long position. The person holding the long position can take physical delivery of the digital currency from the Long's clearing firm account. The long position holder directs its bank to remit the funds for the digital currency purchase to the Short positions bank account. When the long has taken delivery, electronic or physical validation is provided back to the Short via the Exchange clearing house and the clearing firm holding the short position. Similarly confirmation of receipt of funds is provided by the short position to long.

Options Delivery Process

### Delivery Procedures for Call Options:

1. The holder of the Long Call position will make a declaration of his/her intent to take delivery of the digital currency to the Exchanges clearing house. The Exchange's clearing house tallies up all the Long Call and Short Call positions for the options contract.
2. In step 2 of the delivery process, the holder of the Short Call position delivers to his/her clearing firm designated PPED or electronic registry holding the digital currency for the delivery value. The Short Call's clearing firm deposits the PPED or electronic registry holding the digital currency in a secure physical vault under the Short Call's account. The Short Call's clearing firm then provides validation certificate that the holder of the Short Call has deposited the required the digital currency in a specified format. This certification may be in form of an electronic or physical device.
3. As per instruction of the holder of the Short Call, Short Call's clearing firm transfer the PPED or electronic registry holding the digital currency to the Exchange's clearing house vault. This transfer is recorded and due validation is provided by Long Call's clearing firm.
4. The Exchange's clearing house then transfers the PPED or electronic registry holding the digital currency from its vault account to the clearing firm holding the Long Call position.
5. The person holding the Long Call position can take physical delivery of the PPED or electronic registry holding the digital currency from the Long Call's clearing firm account. The Long Call position holder directs its bank to remit the funds for the digital currency purchase to the Short Call's positions bank account. When the Long Call has taken delivery, electronic or physical validation is provided back to the holder of the Short Call via the Exchange clearing house.

### Delivery Procedures for Put Options:

1. The holder of the Short Put position will make a declaration of his/her intent to take delivery of the digital currency to the Exchanges clearing house. The Exchange's clearing house tallies up all the Long and Short Put positions for the options contract.
2. In step 2 of the delivery process, the holder of the Long Put position delivers to his/her clearing firm designated PPED or electronic registry holding the digital currency for the delivery value. The Long Put's clearing firm deposits the PPED or electronic registry holding the digital currency in a secure physical vault under the Long Put's account. The Long Put's clearing firm then provides a validation certificate that the holder of the Long Put has deposited the required the digital currency in a specified format. This certification may be in form of an electronic or physical device.
3. As per instruction of the holder of the Long Put, Long Put's clearing firm transfer the PPED or electronic registry holding the digital currency to the Exchange's clearing house vault. This transfer is recorded and due validation is provided by the Long Put's clearing firm.
4. The Exchange's clearing house then transfers the PPED or electronic registry holding the digital currency from its vault account to the clearing firm holding the Short Put position.
5. The person holding the Short Put position can take physical delivery of the PPED or electronic registry holding the digital currency from the Short Put's clearing firm account. The Short Put position holder directs its bank to remit the funds for the digital currency purchase to the Long Put's positions bank account. When the Short Put holder has taken delivery, electronic or physical validation is provided back to the holder of the Long Put via the Exchange clearing house.

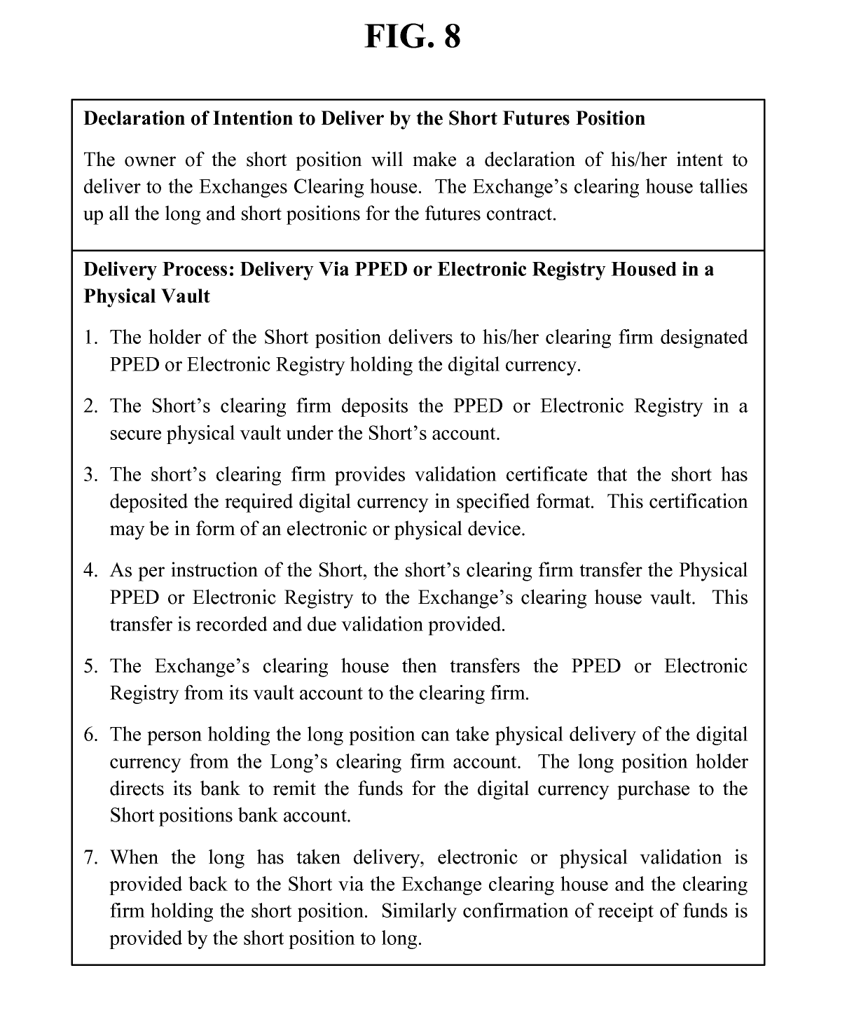

FIG. 8 describes the various delivery alternatives presented as unique in this invention with regard to futures contracts. The futures contracts themselves represent novel features of the invention. These delivery alternatives also present a novel means of delivering the digital currency in physical form.

A preferred embodiment of the present invention relates to providing improved processes or systems for clearing such transactions and providing a trusted infrastructure behind such trading. In some embodiments, the register is a standalone database which can include an associated computer. The database is not connected to any networks, such as LANs, WANs, cellular networks, or near field networks. The database and its associated computer does not have physical or wireless communications connections to other computers or devices such mobile devices, routers, and servers. The database is implemented to provide the ability to add Bitcoins (or generally speaking any other digital currency) to the register only through electromechanical ports (e.g., USB), drives, or input means. The database is disconnected from networks in order to secure the data from potential hacking or unauthorized access to the digital currency in the register. The database and its associated computer can have software onboard for providing additional security such as for performing virus scans on USBs or other media to prevent a worm or other virus to cause damage to the database or computer.

When at the conclusion of trade transaction, the digital currency is required, the digital currency is removed from the database using electronic media such as USB and delivered to a system that will handle the associated transfer transaction. The database and electronic medium are preferably under physical security such as by being located within the same building under physical security protocols. Physical security can be a physical storage vault for the electronic register a well as other options. The database will include information identifying associated users who deposited the digital currency in the register. The database and associated computer will include software including an interactive interface that permits users to view the current state of digital currency holdings for each user and if desired, perform an automatic operation to move an amount of digital currency from the database to an electronic medium (for the purpose of carrying the medium to another machine that is connected to a network such a LAN, WAN, or the Internet).

In some embodiments, when a user deposits an amount of digital currency with the register, the deposit will be reflected in the public ledger. The deposit can be recorded as being a transfer of the digital currency form the owner/user to the register (the clearing system/clearing company). This is one way of implementing an escrow or deposit of digital currency by actually transferring “ownership” to the clearing company. At the completion of the trade, the transfer of digital currency is performed using private information (e.g., the public and private keys of counterparty clearing firms) of the clearing companies that are associated with the trade.

Note any of the functions, method steps or processes of the invention can be performed by one or more hardware or software devices, processes or other entities. These entities can reside in the same location or can reside remotely as, for example, entities interconnected by a digital network such as the Internet, a local area network (LAN), campus or home network, standalone system, etc. Although functions may have been described as occurring simultaneously, immediately or sequentially, other embodiments may perform the functions, steps or processes in a different order, or at substantially different times with respect to execution of other functions, steps or processes.

It will be understood that the systems and software described herein include, either explicitly or implicitly, software implemented on computers or other appropriate hardware, including such other intelligent data processing devices having processors, data storage means, and the ability to support an operating system, with or without user interfaces, for example, file servers, as may be useful in implementing this invention.

Preferred embodiments of the invention provide program product, which can cause a general-purpose computer to operate as a special-purpose computer, in accordance with the disclosure herein. Such program product implemented on a general-purpose computer constitutes an electronic customizing machine which can interact with a magnetically or optically cooperative computer-based input device enabling the computer to be customized as a special purpose computer, according to the contents of the software. To cause a computer to operate in such a customized, special-purpose mode, the software of the invention can be installed by a user or some other person, and will usually interact efficiently with the device on which it resides to provide the desired special-purpose functions or qualities, but only after the selection of configuration parameters which are often unique to the operating system(s) used by the computer. When so configured, the special-purpose computer device has an enhanced value, especially to the professional users for whom it may be intended.

It is to be understood that the terms “computer,” “server,” “data storage means,” as well as cognate terms, denote either physical or logical instances of those entities. For instance, a computer, data storage means and server may be implemented as separate physical entities or as one physical entity performing logically separate functions. Similarly two servers may be implemented as separate physical entities or as one physical entity performing logically separate functions. Also, a computer may be envisaged as a “terminal” which will be understood to include mobile devices (e.g., mobile phones or PDAs) as well as stationary computers.

Finally, one of ordinary skill in the art would therefore understand that various changes and modifications could be made without departing from the spirit and scope of the invention as defined by the claims.

What is claimed is:

1. A method to facilitate trading of digital currencies, which comprises:
electronically storing an amount of a digital currency on an electronic storage device or electronic registry; and
physically storing the storage device or electronic registry in a secure, physical repository that is not publicly accessible with the storage device available for use in subsequent delivery of the digital currency.

2. The method of claim 1, which further comprises authenticating the storing of the storage device or electronic registry in the repository to assure that the digital currency is legitimate.

3. The method of claim 1, which further comprises delivering the storage device or electronic registry to a clearing entity in advance of or in connection with a transfer of the digital currency to another entity to complete a trade.

4. The method of claim 1, which further comprises providing the storage device or electronic registry with security protocols to limit access to the amount of digital currency therein to a limited number of authorized individuals that possess appropriate passwords.

5. The method of claim 1, wherein the electronic storage device is a Universal Serial Bus (USB), flash drive, portable drive or external hard drive, and the physical repository is a safe, storage chamber, storage locker, file, drawer, or other repository that includes appropriate security features.

6. A method for improving delivery during trading of digital currency which comprises;
providing a clearing entity with an electronic identification of an amount of digital currency that is available for trading by a holder of the digital currency, with the electronic identification substantiated by an electronic storage device or electronic registry that includes the amount of digital currency, wherein the storage device is held in a secure, physical repository that is not publicly accessible;
trading contracts for the digital currency electronically through the clearing entity; and
transferring an amount of digital currency from the holder to a buyer when the holder's contracts require such delivery, wherein the amount of digital currency to be transferred is provided from the amount that is stored on the storage device or electronic registry.

7. The method of claim 6, wherein the contracts are option contracts or futures contracts that are traded through cloud communication and the amount to be transferred is that which is due from the holder when the holder's contracts do not offset.

8. The method of claim 6, wherein the trading is conducted through cloud communication between digital currency holders that are listed on an electronic register that is established by the clearing entity or a designated central regulatory organization based on the credit worthiness or membership of the digital currency holder.

9. The method of claim 6, which further comprises exercising a call option on the digital currency to obtain physical delivery of the storage device or electronic registry.

10. The method of claim 6, which further comprises exercising a put option on the digital currency by physical delivery of the storage device or electronic registry.

11. The method of claim 6, which further comprises authenticating the storing of the storage device or electronic registry in the repository to assure that the digital currency is legitimate.

12. The method of claim 6, which further comprises providing the storage device or electronic registry with security protocols to limit access to the amount of digital currency therein to a limited number of authorized individuals that possess appropriate passwords.

13. The method of claim 6, wherein the electronic storage device is a Universal Serial Bus (USB), flash drive, portable drive or external hard drive, and the physical repository is a safe, storage chamber, storage locker, file, drawer, or other repository that includes appropriate security features.

14. The method of claim 6, wherein the secure, physical repository is maintained by the clearing entity or a financial institution.

15. A computerized based method for facilitating trading of contracts for digital currency in an organized market environment, which comprises:
establishing participant accounts in a registry which is maintained by a clearing entity, wherein digital currency in a seller's account is supported by a physical portable electronic device or electronic registry that includes a quantity of digital currency stored in memory therein, wherein the electronic device is held in a secure, physical repository that is not publicly accessible;
conducting trades of contracts for the digital currencies between buyer and seller market participants; and
crediting and debiting a quantity of digital currency from the participant accounts and electronically recording such transactions in the registry;
wherein the method manages exposure to price volatility in the market for digital currencies by providing low-cost, financially guaranteed transactions due to the availability of the digital currency on the seller's physical portable electronic device or electronic registry.

16. The method of claim 15, wherein the contracts are traded through cloud communication on an exchange platform associated with a computer network to an approved party who desires to acquire or sell the predefined quantity of the digital currency.

17. The method of claim 15, wherein the approved party has a digital currency registry account established with the clearing entity.

18. The method of claim 15, which further comprises providing physical delivery of the seller's physical portable electronic device or electronic registry that includes the appropriate quantity of digital currency therein to the buyer when the contract is exercised.

19. The method of claim 18, wherein the clearing entity has the sole ability for account management, recordation and monitoring of the registry.

20. The method of claim 19, wherein the buyer and seller market participants include natural hedgers, retail establishments, financial institutions, service providers who accept digital currencies as form of payment, suppliers of digital currency, or speculators who participate to assume price risks.

21. The method of claim 15, wherein the clearing entity authenticates that the amount of digital currency is properly documented and is legitimate and the secure, physical repository is maintained by the clearing entity or a financial institution.

22. The method of claim 15, wherein the physical portable electronic device is a Universal Serial Bus (USB), flash drive, portable drive or external hard drive, and the physical repository is a safe, storage chamber, storage locker, file, drawer, or other repository that includes appropriate security features.

23. The method of claim 15, wherein the physical portable electronic device includes sufficient built in security protocols to combat theft, hacking and general loss of data, with the security protocols including one or more of biometric identification, passwords, security tokens, or behavioral patterns.

24. The method of claim 15, wherein the physical portable electronic device or electronic registry holds a quantity of digital currency that is greater than the amount traded and the clearing entity adjusts the quantity to the amount traded and transfers the greater amount to a second physical portable electronic device.

25. A computer-based system for facilitating trading of options contracts for digital currency in an organized market environment, which comprises:
a physical portable electronic device or electronic registry that includes a quantity of digital currency stored in memory therein, wherein the electronic device is held in a secure, physical repository that is not publicly accessible;
a server for:
establishing participant accounts in a secure registry which is maintained by a clearing entity, wherein digital currency in a seller's account is supported by the physical portable electronic device;
conducting trades of options contracts for the digital currencies between buyer and seller market participants; and
crediting and debiting a quantity of digital currency from the participant accounts and electronically recording such transactions in the registry;
wherein the system manages exposure to price volatility in the market for digital currencies by providing low-cost, financially guaranteed transactions due to the availability of the digital currency on the seller's physical portable electronic device or electronic registry.

26. The system of claim 25 wherein the trades of contracts and crediting and debiting of digital currency occurs through the cloud.
